(19) United States
(12) Patent Application Publication
(10) Pub. No.: US 2011/0228235 A1
(43) Pub. Date: Sep. 22, 2011

(54) PROJECTOR

(75) Inventor: Chin-Ku LIU, Hsin-Chu (TW)

(73) Assignee: Coretronic Corporation, Hsin-Chu (TW)

(21) Appl. No.: 12/908,587

(22) Filed: Oct. 20, 2010

(30) Foreign Application Priority Data
Mar. 22, 2010 (CN) 201010144696.7

(51) Int. Cl. G03B 21/20

(52) U.S. Cl. 353/119

(57) ABSTRACT

A projector includes a supporting frame, a light source module, and an imaging module. The light source module is fixed with the supporting frame. The light source module is adapted to provide a light beam. The light source module has an optical axis. The optical axis is substantially horizontal. The imaging module is located at an optical path of the light beam. The imaging module has a free end and a connection end opposite to the free end. The free end is adjacent to the light source module. The connection end is connected with the supporting frame. The imaging module is capable of rotating relative to the supporting frame about the optical axis, and therefore a projection location of an emitted light is changed.

### CROSS-REFERENCE TO RELATED APPLICATION

This application claims the priority benefit of China application serial no. 201010144696.7, filed on Mar. 22, 2010. The entirety of the above-mentioned patent application is incorporated herein by reference and made a part of this specification.

### BACKGROUND

1. Technical Field

The invention relates to an optical device, and in particular relates to a rotatable projector.

2. Description of the Related Art

Recently, with the rapid development of consumer electronic products, projectors have been widely used in different fields, such as commercial applications, stage set, and home theater.

FIG. 1 is a schematic view of a conventional projector. FIG. 2 is a schematic, top plan view of configuration of a light source module and an imaging module of the projector of FIG. 1. Referring to FIGS. 1 and 2, the projector 100 includes a fixing base 110, a supporting frame 120, a light source module 130, and an imaging module 140. The supporting frame 120 is pivotally connected with the fixing base 110. The supporting frame 120 can rotate relative to the fixing base 110 about a rotation axis Y. The supporting frame 120 has a first suspending arm 122 and a second suspending arm 124. The light source module 130 and the imaging module 140 are disposed in the same housing 150. The light source module 130 includes a light source 132 and a heat dissipation unit 134. The imaging module 140 includes a plurality of optical elements 142 and a projection lens 144.

A light beam L generated by the light source 132 is refracted and reflected by the optical elements 142, and then the light beam L is emitted out of the housing 150 from the projection lens 144. The housing 150 is pivotally connected between the first suspending arm 122 and the second suspending arm 124, so that the housing 150 can rotate relative to the second suspending arm 124 about a rotation axis X. An optical axis of the light source module 130 coincides with the rotation axis X.

As shown in FIGS. 1 and 2, if the supporting frame 120 rotates relative to the fixing base 110 about the rotation axis Y, or the light source module 130 and the imaging module 140 rotate relative to the second suspending arm 124 about the rotation axis X, projection location of the light beam emitted from the projection lens 144 would be changed correspondingly.

In general, ultra-high pressure mercury lamp (UHP) with high light collection efficiency has some constraints of horizontal angle in use.

### BRIEF SUMMARY

The invention provides a projector, which has at least one of the following advantages: enhancing light collection efficiency and improving flexibility of use.

Other advantages and objects of the invention may be further comprehended through the technical features disclosed in the invention.

In order to achieve one or part of or all the objectives or other objectives, a projector is provided in an embodiment of the invention. The projector includes a supporting frame, a light source module, and an imaging module. The light source module is fixed with the supporting frame. The light source module is adapted to provide a light beam. The light source module has an optical axis. The optical axis is substantially horizontal. The imaging module is located at an optical path of the light beam. The imaging module has a free end and a connection end opposite to the free end. The free end is adjacent to the light source module. The connection end is connected with the supporting frame. The imaging module is capable of rotating relative to the supporting frame about the optical axis.

In order to achieve one or part of or all the objectives or other objectives, a projector is provided in another embodiment of the invention. The projector includes a supporting frame, a light source module, an imaging module, and a first driving module. The light source module is fixed with the supporting frame. The light source module is adapted to provide a light beam. The light source module has an optical axis. The imaging module is located at an optical path of the light beam. The first driving module is pivotally connected with the supporting frame and adapted to rotate relative to the supporting frame about the optical axis. The imaging module is fixed with the first driving module.

In order to achieve one or part of or all the objectives or other objectives, a projector is provided in another embodiment of the invention. The projector includes a supporting frame, a light source module, an imaging module, and a first driving module. The light source module is fixed with the supporting frame. The light source module is adapted to provide a light beam. The light source module has an optical axis. The imaging module is located at an optical path of the light beam. The imaging module has a free end and a connection end opposite to the free end. The free end is adjacent to the light source module. The first driving module is fixed with the connection end of the imaging module. The first driving module is pivotally connected with the supporting frame and adapted to rotate relative to the supporting frame about the optical axis.

In order to achieve one or part of or all the objectives or other objectives, in another embodiment of the invention, a projector is provided. The projector includes a supporting frame, a light source module, an imaging module, and a first driving module. The light source module is fixed with the supporting frame. The light source module is adapted to provide a light beam. The light source module has an optical axis. The optical axis is substantially horizontal. The imaging module is located at an optical path of the light beam. The imaging module has a free end and a connection end opposite to the free end. The free end is adjacent to the light source module. The first driving module is fixed with the connection end of the imaging module. The first driving module is pivotally connected with the supporting frame and adapted to rotate relative to the supporting frame about the optical axis.

In the projector of the embodiment of the invention, the light source module is fixed with the supporting frame, so that the horizontal position of the light source module is maintained. In the other side, the imaging module could rotate relative to the supporting frame about the optical axis of the light source module, so that projection location of the emitted light beam could be changed correspondingly. As mentioned above, the projector of the embodiments of the invention has at least one of the following advantages or other advantages. In the projector of the embodiment of the invention, the projection location of the light beam could be changed without tilting the light source module. Therefore, the lamp with high light collection efficiency may be used as the light source, and thus the projector could enhance light collection efficiency and improve flexibility of use.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 a schematic view of a conventional projector.

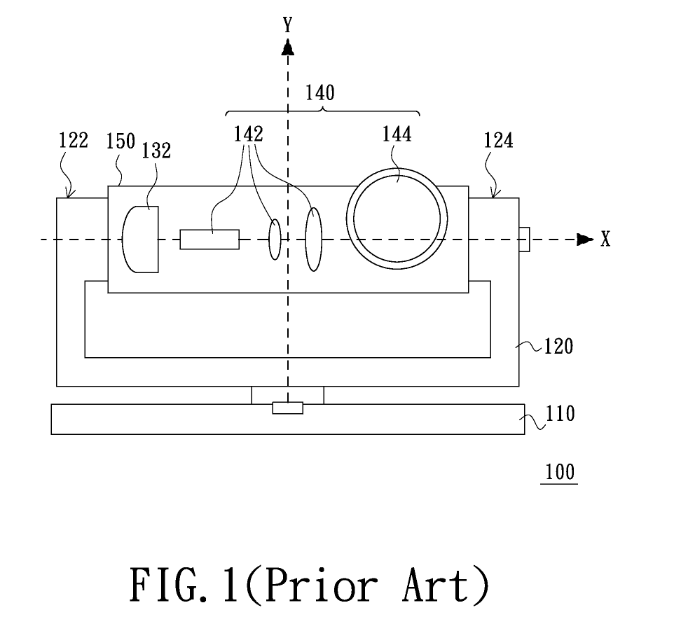

FIG. 2 is a schematic, top plan view of configuration of a light source module and an imaging module of the projector of FIG. 1.

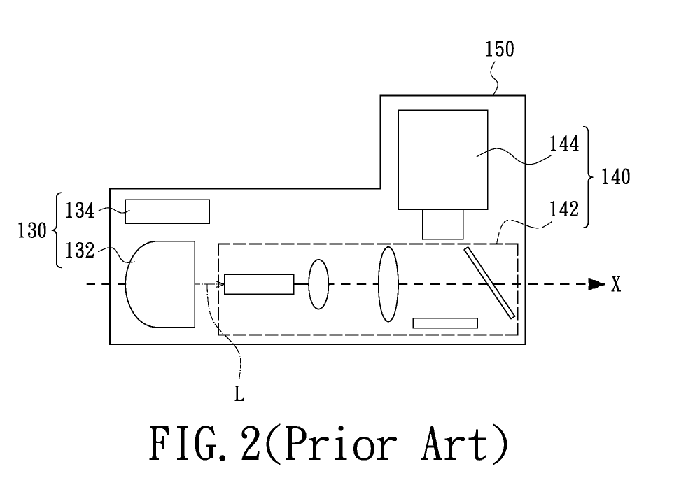

FIG. 3 is schematic view of a projector in accordance with an embodiment of the invention.

FIG. 4 is a schematic view of configuration of a light source module and an imaging module of the projector of FIG. 3.

FIG. 5 is schematic view of a projector in accordance with another embodiment of the invention.

### DETAILED DESCRIPTION

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

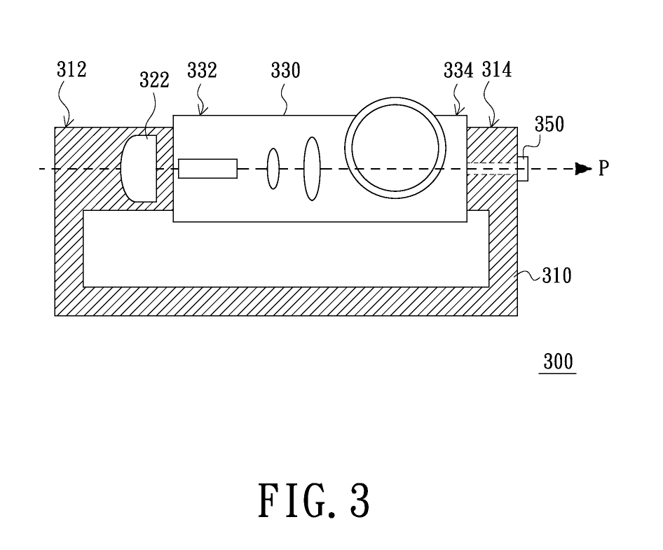

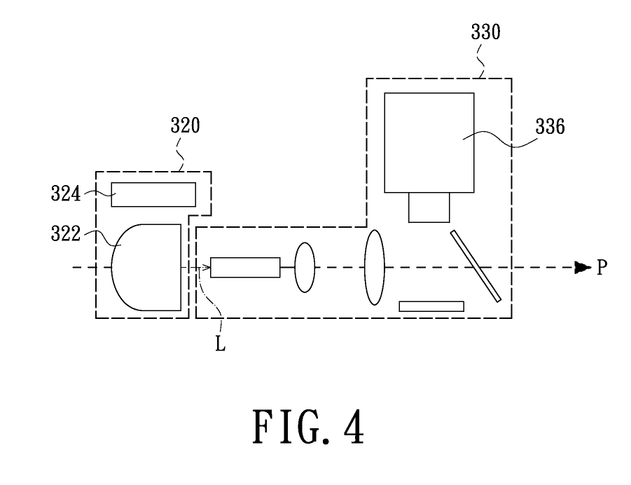

FIG. 3 is schematic view of a projector in accordance with an embodiment of the invention. FIG. 4 is a schematic view of configuration of a light source module and an imaging module of the projector of FIG. 3. Referring to FIGS. 3 and 4, the projector 300 can be a digital projector, a GOBO lamp, a wall washer or a searchlight, but not limited hereto. The projector 300 includes a supporting frame 310, a light source module 320, and an imaging module 330. The supporting frame 310 includes a first suspending arm 312 and a second suspending arm 314. The light source module 320 is fixed with the first suspending arm 312, and has an optical axis P. In details, in the embodiment, the optical axis P may be substantially horizontal. In other words, the optical axis P may be substantially parallel with the horizon. Specially, in the embodiment, the light source module 320 is embedded in the first suspending arm 312, but not limited hereto.

The light source module 320 may include, for example, a light source 322 and a heat dissipation unit 324. The light source 322 is adapted to provide a light beam L and the light beam L is emitted with a predetermined angle between the light beam L and the optical axis P. In the embodiment, the predetermined angle between the light beam L and the optical axis P may be 0 degree. In other words, the light beam L provided by the light source module 320 is emitted along the optical axis P, but not limited hereto. The heat dissipation unit 324 is adjacent to the light source 322, and is adapted to dissipate heat generated by the light source 322 to outside of the light source module 320. For example, the heat dissipation unit 324 may include a fan.

Referring to FIGS. 3 and 4 again, the imaging module 330 is located at an optical path of the light beam L. The imaging module 330 has a free end 332 and a connection end 334 opposite to the free end 332. The free end 332 is adjacent to the light source module 320. The free end 332 is separated from the light source module 320. The light beam L provided by the light source module 320 incidents into the imaging module 330 via the free end 332, and then the light beam L is emitted out of the imaging module 330 from a projection lens 336 to project on a predetermined location.

The connection end 334 of the imaging module 330 is connected with the supporting frame 310. The imaging module 330 is capable of rotating relative to the supporting frame 310 about the optical axis P, so that the projection location of the light beam L would be changed correspondingly. In the embodiment, the connection end 334 of the imaging module 330 is, for example, connected with the second suspending arm 314 of the supporting frame 310.

If the projection location of the light beam L of the projector 300 needs to be adjusted, the imaging module 330 may rotate relative to the supporting frame 310 so as to change the projection location of the light beam L correspondingly. In the same time, the light source module 320 could be fixed relative to the supporting frame 310, so that the optical axis P may be maintained substantially parallel with the horizon. As such, even if the light source 332 of the projector 300 is ultra-high pressure mercury lamp that has some constraints of horizontal angle in use, the projection location of the light beam L of the projector 300 could be adjusted optionally without affecting the usage of the light source 332.

To adjust the projection location of the light beam L of the projector 300 easily, the projector 300 can further include a first driving module 350. In details, the first driving module 350 is pivotally connected with the second suspending arm 314 of the supporting frame 310, and the first driving module 350 could rotate relative to the supporting frame 310 about the optical axis P. The imaging module 330 is fixed with the first driving module 350 at the connection end 334. Therefore the imaging module 330 could rotate with the first driving module 350 relative to the supporting frame 310 about the optical axis P. In details, the first driving module 350 may be, for example, a motor (unshown), and the imaging module 330 could be fixed with a rotation shaft of the motor.

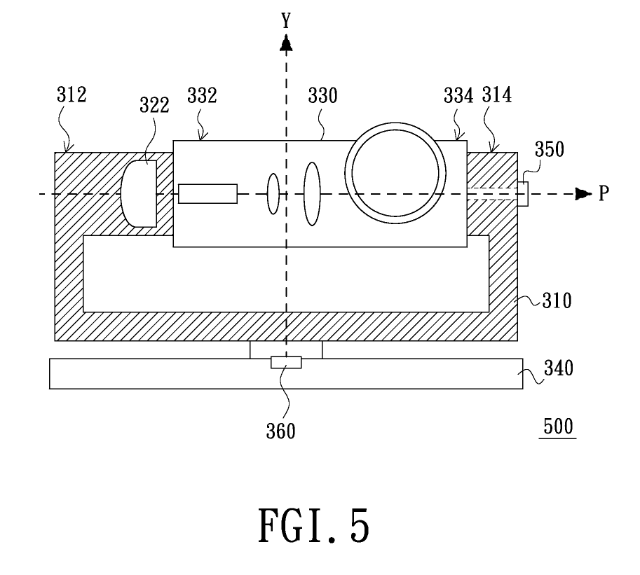

FIG. 5 is a schematic view of a projector in accordance with another embodiment of the invention. Referring to FIG. 5, the projector 500 is similar to the projector 300 in principle, and the difference between the projector 500 and the projector 300 lies in that the projector 500 further includes a fixing base 340. The supporting frame 310 is connected with the fixing base 340. The supporting frame 310 could rotate relative to the fixing base 340 about a rotation axis Y. The rotation axis Y is substantially perpendicular to the optical axis P. Consequently, in the projector 500, the projection location of the light beam L could be adjusted by the imaging module 330 rotating relative to the supporting frame 310 and by the supporting frame 310 rotating relative to the fixing base 340.

Referring to FIG. 5 again, the projector 500 may further include a second driving module 360. The second driving module 360 is pivotally connected with the fixing base 340. The second driving module 360 could rotate relative to the fixing base 340 about the rotation axis Y. The supporting frame 310 is fixed with the second driving module 360. Therefore, the supporting frame 310 could rotate with the second driving module 360 relative to the fixing base 340 about the rotation axis Y. In details, the second driving module 360 may be, for example, a motor, and the supporting frame 310 could be fixed with a rotation shaft of the motor.

As mentioned above, the projector of the embodiments of the invention has at least one of the following advantages or other advantages.

In the projector of the embodiment of the invention, the light source module is fixed with the supporting frame, so that the horizontal location of the light source module could be maintained. In the other side, the imaging module could rotate relative to the supporting frame about the optical axis of the light source module, so that projection location of the light beam could be changed correspondingly. Consequently, in the projector of the embodiment of the invention, the projection location of the light beam could be changed without tilting the light source module. Therefore, the lamp with high light collection efficiency could be used as the light source, and thus the projector could enhance light collection efficiency and improve flexibility of use.

Furthermore, in the projector of the embodiment of the invention, the light source together with the heat dissipation unit is fixed with the supporting frame. As such, if the projection location of the light beam is adjusted by the imaging module rotating relative to the supporting frame, the relative position between the light source and the heat dissipation unit would not change, so that the heat generated by the light source could be dissipated effectively.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A projector comprising:
a supporting frame;
a light source module fixed with the supporting frame, adapted to provide a light beam, and having a optical axis; and
an imaging module located at an optical path of the light beam, and having a free end and a connection end opposite to the free end, the free end adjacent to the light source module, the connection end connected with the supporting frame, the imaging module capable of rotating relative to the supporting frame about the optical axis.

2. The projector according to claim 1, wherein the supporting frame has a first suspending arm and a second suspending arm, the light source module is embedded in the first suspending arm, and the connection end of the imaging module is connected with the second suspending arm.

3. The projector according to claim 2, wherein the free end of the imaging module is separated from the light source module.

4. The projector according to claim 1, further comprising a first driving module pivotally connected with the supporting frame and adapted to rotate relative to the supporting frame about the optical axis, and the imaging module fixed with the first driving module.

5. The projector according to claim 1, wherein the light source module comprises a light source and a heat dissipation unit.

6. The projector according to claim 1, further comprising a fixing base, wherein the supporting frame is connected with the fixing base and adapted to rotate relative to the fixing base about a rotation axis, and the rotation axis is substantially perpendicular to the optical axis.

7. The projector according to claim 6, further comprising a second driving module pivotally connected with the fixing base and adapted to rotate relative to the fixing base about the rotation axis, and the supporting frame fixed with the second driving module.

8. A projector comprising:
a supporting frame;
a light source module fixed with the supporting frame, adapted to provide a light beam, and having an optical axis;
an imaging module located at an optical path of the light beam, and
a first driving module pivotally connected with the supporting frame and adapted to rotate relative to the supporting frame about the optical axis, the imaging module fixed with the first driving module.

9. The projector according to claim 8, wherein the supporting frame has a first suspending arm and a second suspending arm, the light source module is embedded in the first suspending arm, and the first driving module is pivotally connected with the second suspending arm.

10. The projector according to claim 8, wherein the light source module comprises a light source and a heat dissipation unit.

11. The projector according to claim 8, further comprising a fixing base, wherein the supporting frame is connected with the fixing base and adapted to rotate relative to the fixing base about a rotation axis, and the rotation axis is substantially perpendicular to the optical axis.

12. The projector according to claim 11, further comprising a second driving module pivotally connected with the fixing base and adapted to rotate relative to the fixing base about the rotation axis, and the supporting frame fixed with the second driving module.

13. A projector comprising:
a supporting frame;
a light source module fixed with the supporting frame, adapted to provide a light beam, and having an optical axis;
an imaging module located at an optical path of the light beam, and having a free end and a connection end opposite to the free end, the free end adjacent to the light source module; and
a first driving module fixed with the connection end of the imaging module, pivotally connected with the supporting frame and adapted to rotate relative to the supporting frame about the optical axis.

14. The projector according to claim 13, wherein the supporting frame has a first suspending arm and a second suspending arm, and the light source module is fixed in the first suspending arm, and the first driving module is pivotally connected with the second suspending arm.

15. The projector according to claim 14, wherein the free end of the imaging module is separated from the light source module.

16. The projector according to claim 13, wherein the light source module comprises a light source and a heat dissipation unit.

17. The projector according to claim 13, further comprising a fixing base, wherein the supporting frame is pivotally connected with the fixing base and adapted to rotate relative to the fixing base about a rotation axis, and the rotation axis is substantially perpendicular to the optical axis.

18. The projector according to claim 17, further comprising a second driving module pivotally connected with the fixing base and adapted to rotate relative to the fixing base about the rotation axis, and the supporting frame fixed with the second driving module.
